(19) United States
(12) Patent Application Publication
(10) Pub. No.: US 2017/0306464 A1
(43) Pub. Date: Oct. 26, 2017

(54) BEARING COMPONENT FORMED FROM A STEEL ALLOY

(71) Applicant: Aktiebolaget SKF, Goteborg (SE)

(72) Inventors: Mohamed Sherif, Hilversum (NL); Urszula Alicja Sachadel, Utrecht (NL)

(21) Appl. No.: 15/528,677

(22) PCT Filed: Nov. 24, 2015
(86) PCT No.: PCT/EP2015/077436

§ 371 Date: May 22, 2017

(30) Foreign Application Priority Data
Nov. 27, 2014 (GB) 1421048.8

(51) Int. Cl. C22C 38/50; C22C 38/00; C22C 38/02; C22C 38/04; C22C 38/60; C22C 38/46; B22D 11/00; C22C 38/42; C22C 38/06; C22C 38/44; F16C 33/62

(52) U.S. Cl. CPC C22C 38/50; C22C 38/44; C22C 38/001; C22C 38/008; C22C 38/02; F16C 33/62; C22C 38/60; C22C 38/46; B22D 11/001; C22C 38/42; C22C 38/06; C22C 38/04; F16C 2204/64; F16C 2204/70; F16C 2204/72; F16C 2220/02

(57) ABSTRACT

A bearing component formed from a steel alloy having from 0.7 to 0.9 wt. % carbon, from 0.05 to 0.16 wt. % silicon, from 0.7 to 0.9 wt. % manganese, from 1.4 to 2.0 wt. % chromium, from 0.7 to 1.0 wt. % molybdenum, from 0.03 to 0.15 wt. % vanadium, from 0 to 0.25 wt. % nickel, from 0 to 0.3 wt. % copper, from 0 to 0.2 wt. % cobalt, from 0 to 0.1 wt. % aluminum, from 0 to 0.1 wt. % niobium, from 0 to 0.2 wt. % tantalum, from 0 to 0.025 wt. % phosphorous, from 0 to 0.015 wt. % sulphur, from 0 to 0.075 wt. % tin, from 0 to 0.075 wt. % antimony, from 0 to 0.04 wt. % arsenic, from 0 to 0.002 wt. % lead, up to 350 ppm nitrogen, up to 20 ppm oxygen, up to 50 ppm calcium, up to 30 ppm boron, up to 50 ppm titanium, the balance iron, together with any unavoidable impurities.

### FIELD OF THE INVENTION

The present invention relates generally to the field of metallurgy and to a bearing component formed from a steel composition. The steel may be manufactured by a continuous casting process.

### BACKGROUND OF THE INVENTION

Bearings are devices that permit constrained relative motion between two parts. Rolling element bearings comprise inner and outer raceways and a plurality of rolling elements (balls or rollers) disposed there-between. For long-term reliability and performance it is important that the various elements, which are typically formed from a bearing steel, have resistance to rolling contact fatigue, wear and creep. Another important characteristic of bearing steels is the hardenability, i.e. the depth up to which the alloy is hardened after putting it through a heat-treatment process.

An example of a type of bearing steel is Material Number (Werkstoff) 1.3536 (DIN 100CrMo7-3). This typically contains 1.0 wt. % C, 0.30 wt. % Si, 0.70 wt. % Mn, 1.80 wt. % Cr, 0.30 wt. % Mo, and the balance Fe and any unavoidable impurities.

Continuous casting is an increasingly widely used process in the manufacture of metal articles. The process involves the solidification of molten metal into a semi-finished billet, bloom, or slab for subsequent surface machining, heat treatment and hot working in the finishing mills. Continuous casting provides improved yield, productivity and cost efficiency.

Macro-segregation during casting arises owing to the difference in the solubility of the dissolved elements in the liquid and solid phases. The result is non-uniformity in the chemical composition of the steel, which can be detrimental to mechanical properties and day-to-day performance of the cast steel article. Macro-segregation refers to variations in composition that occur in alloy castings or ingots and range in scale from several millimeters to centimeters.

### BRIEF SUMMARY OF THE INVENTION

It is an aim of the present invention to provide a bearing component formed from a steel composition which offers good mechanical properties and which can be manufactured by a process involving continuous casting.

The aforementioned aim is achieved by means of a bearing component formed from a steel alloy comprising:

from 0.7 to 0.9 wt. % carbon,
from 0.05 to 0.16 wt. % silicon,
from 0.7 to 0.9 wt. % manganese,
from 1.4 to 2.0 wt. % chromium,
from 0.7 to 1.0 wt. % molybdenum,
from 0.03 to 0.15 wt. % vanadium,
from 0 to 0.25 wt. % nickel,
from 0 to 0.3 wt. % copper,
from 0 to 0.2 wt. % cobalt,
from 0 to 0.1 wt. % aluminium,
from 0 to 0.1 wt. % niobium,
from 0 to 0.2 wt. % tantalum,
from 0 to 0.025 wt. % phosphorous,
from 0 to 0.015 wt. % sulphur,
from 0 to 0.075 wt. % tin,
from 0 to 0.075 wt. % antimony,
from 0 to 0.04 wt. % arsenic,
from 0 to 0.002 wt. % lead,
up to 350 ppm nitrogen,
up to 20 ppm oxygen,
up to 50 ppm calcium,
up to 30 ppm boron,
up to 50 ppm titanium,
the balance iron, together with any unavoidable impurities.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In the present invention, the steel alloy composition used in the bearing component comprises from 0.7 to 0.9 wt. % carbon, preferably from 0.7 to 0.8 wt. % carbon, more preferably from 0.72 to 0.78 wt. % carbon, still more preferably from 0.73 to 0.77 wt. %. In combination with the other alloying elements, this results in a desired microstructure and properties. The reduced carbon content has also been found to result in lower levels of macro-segregation in continuously cast articles such as billets or blooms without an adverse effect on the hardness of the hardened bearing components. Furthermore, the reduced carbon content means that it is easier to butt-weld the steel compared to conventional bearing steels with higher carbon contents.

The steel alloy composition comprises from 0.05 to 0.16 wt. % silicon, preferably from 0.06 to 0.16 wt. % silicon, still more preferably from 0.08 to 0.14 wt. % silicon, still more preferably from 0.09 to 0.12 wt. % silicon, still more preferably from 0.1 to 0.12 wt. % silicon. In combination with the other alloying elements, this results in the desired microstructure with a minimum amount of retained austenite. Silicon helps to suppress the precipitation of cementite and carbide formation. Silicon may also resist softening during tempering. However, too high a silicon content may result in undesirable surface oxides and a poor surface finish. For this reason, the maximum silicon content is preferably 0.16 wt. %. Steels with high silicon content tend to retain more austenite in their hardened structures due to the carbide-suppressing characteristics of the element. It follows that the steel concentration of silicon can be reduced to lower the retained austenite content. Moreover, a silicon content within the prescribed range has also been found to result in lower levels of macro-segregation in continuously cast blooms and billets from which articles are manufactured.

The steel composition comprises from 0.7 to 1.0 wt. % molybdenum, preferably from 0.7 to 0.9 wt. % molybdenum, more preferably from 0.7 to 0.85 wt. % molybdenum, still more preferably from 0.7 to 0.8 wt. % molybdenum. Molybdenum may act to avoid grain boundary embrittlement and contributes to the resistance to tempering. However, higher molybdenum contents may have an adverse effect in relation to bainite transformation.

A molybdenum content within the prescribed range may also result in lower levels of macro-segregation in continuously cast blooms and billets from which articles are manufactured. In particular, it has been found that a Mo/Si weight ratio of preferably from 3.5 to 33.3, more preferably from 4 to 20, still more preferably from 5 to 20, still more preferably from 6 to 20, still more preferably from 6 to 15, still more preferably from 6.5 to 15, still more preferably from 6.6 to 14.5, still more preferably from 7 to 14, helps ensure decreased segregation during solidification of the steel.

The steel composition comprises from 1.4 to 2.0 wt. % chromium. Apart from its positive effect on hardenability, the content of chromium has been found to have a bearing on the type of carbide obtained during hardening. If the concentration of chromium is too low, the relatively undesirable cementite phase is stabilized. The alloy therefore preferably comprises at least 1.5 wt. % chromium. On the other hand, the chromium content must be restricted, for example, to ensure sufficient carbon in solid solution in the austenite phase during hardening. For the austenite to transform into a sufficiently hard structure at lower temperatures during quenching (57 to 63 HRC), it must possess sufficient dissolved carbon and optionally nitrogen. The steel alloy therefore comprises a maximum of 2.0 wt. % chromium. The steel composition preferably comprises from 1.5 to 1.8 wt. % chromium, more preferably from 1.6 to 1.7 wt. % chromium.

The Cr/C weight ratio is preferably 2 since this has been found to help control the fluidity of the inter-dendritic steel liquid in between the fully austenitic dendrites during solidification.

The alloy preferably comprises molybdenum and chromium in a weight ratio of 0.35≦Mo/Cr≦0.71, more preferably in a weight ratio of 0.4≦Mo/Cr≦0.6. Such a ratio may enhance the thermodynamic stability of Cr-rich carbides.

The steel alloy composition comprises from 0.7 to 0.9 wt. % manganese. Manganese acts to increase the stability of austenite relative to ferrite. Manganese may also act to improve hardenability.

With a lower steel carbon content, the overall percentage of carbides that is retained during hardening is typically low, which has the benefit that there are typically fewer sites that may initiate micro-cracks. On the other hand, with less carbides retained during austenitisation, the risk of austenite grain growth, which is detrimental to mechanical properties and fatigue, is higher. The steel alloy comprises from 0.03 to 0.15 wt. % vanadium. For example, from 0.03 to 0.12 wt. % vanadium, preferably from 0.04 to 0.12 wt. % vanadium, more preferably from 0.05 to 0.1 wt. % vanadium. The addition of vanadium to the steel enables the formation of nano-sized vanadium-rich precipitates (for example carbides, nitrides and/or carbonitrides) that form once the hot-worked components are properly cooled to room temperature. Such fine precipitates may pin the prior austenite grain boundaries. Consequently, compared with conventional bearing steels, the steel composition according to the present invention can be resistant to over-austenitisation. In other words, the steel can be austenitised at a relatively high temperature without excessive austenite grain growth. Additionally, the somewhat higher austenitisation temperature such as, for example 905° C., ensures better dissolution of solute elements (for example, chromium) that improve hardenability. Such an austenitisation temperature, combined with the steel chemistry, means that a minimal content of cementite is retained in the hardened bearing component. As a result, the toughness of the bearing steel component can be improved, as can the fatigue life and tolerance to micro-defects.

In addition, and again to prevent any possible excessive austenite grain growth during hardening, it may be beneficial to add other micro-alloying additions, and optionally nitrogen, such that small, very fine precipitates, which pin the prior austenite grain boundaries, are formed. For this purpose, the elements Ta and/or Nb may be added to form carbides, nitrides and/or carbonitrides.

In some embodiments, nitrogen is added such that the steel alloy comprises from 50 to 350 ppm nitrogen, preferably between 100 and 350 ppm nitrogen. In other embodiments, there is no deliberate addition of nitrogen. Nevertheless, the alloy may necessarily still comprise at least 50 ppm nitrogen due to exposure to the atmosphere.

Preferably, the steel alloy comprising added nitrogen, further comprises one or more of the following alloying elements in the following weight percentages: up to 0.1 wt. % niobium; and up to 0.2 wt. % tantalum.

In the present work, it has been found that the formation of vanadium-rich and nitrogen-containing precipitates significantly improves both the strength and hardness of the final bearing steel structures, which leads to better resistance to rolling contact fatigue.

In examples of the steel alloy which comprises vanadium and added nitrogen, the formation of vanadium-rich and nitrogen-containing precipitates is favoured over the formation of vanadium carbide since the former is more stable thermodynamically. For a given fraction of vanadium carbides and vanadium nitrides the vanadium nitrides tend to be smaller, more stable and as such more effective in pinning prior austenite grain boundaries. Vanadium-rich and nitrogen-containing precipitates also contribute more to the strengthening of the bearing steel structure.

Preferably, the steel alloy comprises no more than 0.1 wt. % aluminium, more preferably no more than 0.05 wt. % aluminium. Aluminium is usually present in such small quantities due to the steel de-oxidation process. Still more preferably, the steel alloy is free of aluminium, especially when the steel alloy comprises one or more of the micro-alloying elements (V and/or Nb and/or Ta). The presence of aluminium in such a case is undesirable, as nitrogen can be lost due to the formation of aluminium nitrides. When the presence of a small amount of aluminium is unavoidable, however, the alloy may comprise aluminium and nitrogen in a weight ratio of 0.014≦Al/N≦0.6, preferably 0.014≦Al/N≦0.1. This ratio ensures that not all of the nitrogen is bound to aluminum, leaving some available to form, for example, vanadium-rich precipitates, thereby refining and stabilizing them.

As noted, the steel composition may also optionally include one or more of the following elements:

from 0 to 0.25 wt. % nickel (for example 0.02 to 0.2 wt. % nickel)

from 0 to 0.3 wt. % copper (for example 0.02 to 0.2 wt. % copper)

from 0 to 0.2 wt. % cobalt (for example 0.05 to 0.2 wt. % cobalt)

from 0 to 0.1 wt. % aluminum (for example 0.05 to 0.1 wt. % aluminum)

from 0 to 0.1 wt. % niobium (for example 0.05 to 0.1 wt. % niobium)

from 0 to 0.2 wt. % tantalum (for example 0.05 to 0.2 wt. % tantalum)

from 0 to 0.035 wt. % nitrogen (for example 50 to 350 ppm nitrogen)

It will be appreciated that the steel alloy referred to herein may contain unavoidable impurities, although, in total, these are unlikely to exceed 0.3 wt. % of the composition. Preferably, the alloys contain unavoidable impurities in an amount of not more than 0.1 wt. % of the composition, more preferably not more than 0.05 wt. % of the composition. In particular, the steel composition may also include one or more impurity elements. A non-exhaustive list of impurities includes, for example:

from 0 to 0.025 wt. % phosphorous

from 0 to 0.015 wt. % sulphur

from 0 to 0.04 wt. % arsenic

from 0 to 0.075 wt. % tin

from 0 to 0.075 wt. % antimony

from 0 to 0.002 wt. % lead

from 0 to 0.003 wt. % boron

The steel alloy composition preferably comprises little or no sulphur, for example from 0 to 0.015 wt. % sulphur.

The steel alloy composition preferably comprises little or no phosphorous, for example from 0 to 0.025 wt. % phosphorous.

The steel composition preferably comprises ≦15 ppm oxygen. Oxygen may be present as an impurity. The steel composition preferably comprises ≦30 ppm titanium. Titanium may be present as an impurity. The steel composition preferably comprises ≦10 ppm boron. Boron may be present as an impurity at, for example, 1-5 ppm.

The steel composition preferably comprises 50 ppm calcium. Calcium may be present as an impurity but may also be added intentionally in very small amounts, for example 1-10 ppm.

The steel alloy composition may consist essentially of the recited elements. It will therefore be appreciated that in addition to those elements that are mandatory other non-specified elements may be present in the composition provided that the essential characteristics of the composition are not materially affected by their presence.

Examples of bearing components according to the present invention include a rolling element (e.g. ball, cylinder or tapered rolling element), an inner ring, and an outer ring. The present invention also provides a bearing comprising a bearing component as herein described.

The steel alloy as herein described may be formed into a bearing component by continuously casting the alloy. The present invention further provides a process for the manufacture of a bearing component, wherein the process comprises:
(i) continuously casting a steel alloy as herein described; and
(ii) forming a bearing component from the continuously cast steel alloy.

The alloy as herein described exhibits reduced macro-segregation and particularly lends itself to continuous casting processes. In particular, a Mo/Si weight ratio of preferably from 3.5 to 33.3, more preferably from 4 to 20, still more preferably from 5 to 20, still more preferably from 6 to 20, more preferably from 6 to 15, has been found useful to reduce segregation in continuously cast billets or blooms. While not wishing to be bound by theory, the Mo/Si ratio within these bounds is believed to help control the fluidity of the inter-dendritic steel liquid in between the fully austenitic dendrites during solidification. In addition, it is preferable to have a Cr/C weight ratio of 2 or more for the same reason.

In the manufacture of a bearing component, the steel alloy composition may be subjected to a heat-treatment (austenitisation) such that the martensite-start temperature is sufficiently depressed such that the formation of a fully bainitic or substantially fully bainitic structure (microstructure) is achieved. By fully bainitic structure is meant that, after austenitisation and subsequent quenching, the steel articles are held at temperatures just above the martensite-start temperature for the transformation into bainite to commence. The bainitic structure is fine and the resulting steel has a high hardness. Optional carbides/nitrides/carbonitrides may also be present.

The steel composition was also found to be suitable for martensitic heat treating and tempering where the steel articles, for example bearing components, are quenched below the martensite start temperature, typically in oil, after austenitisation. The components can then be cooled to room temperature, followed by rinsing in cold water (approximately 5° C.), prior to the final tempering step. The martensitic hardening route has the advantage in terms of cost reduction in view of the process being faster than the bainite transformation process. The material also has a harder structure. Optional carbides/nitrides/carbonitrides may also be present in the microstructure. It is also possible for the steel alloy to comprise a mixed martensitic/bainitic structure, depending on the desired balance between hardness/residual stress profile. Again, optional carbides/nitrides/carbonitrides may also be present.

The optimisation of the Mo/Si weight ratio, for example from 3.5 to 33.3, preferably from 4 to 20, more preferably from 5 to 20, still more preferably from 6 to 20, still more preferably from 6 to 15, does not adversely affect the tempering resistance of the steel. As a consequence, it is possible to achieve a hardness of at least 60 HRC in the final bainite transformed components while, at the same time, providing a steel composition specifically designed for continuous casting. The tempering resistance of the as-hardened structure may also provide superior resistance to rolling contact fatigue.

The present invention will now be described further with reference to a suitable heat treatment for the steel alloy for the bearing component, provided by way of example.

Austenitisation (hardening) of bearing components made from the present steel alloy is typically carried out within the temperature range 800° C.-900° C., preferably 840-900° C., more preferably 840-890° C. for 10 to 70 min, preferably 10 to 60 min. The austenite, refined chromium-rich carbides are primarily present at the end of the austenitisation stage just prior to subsequent cooling. Optionally, as demonstrated in the previous section, vanadium-rich nitrogen-containing precipitates may also be present during hardening. Such vanadium precipitates will aid in refining the austenite grains, especially at higher austenitisation temperatures and/or long holding times typically used when more hardenability is required for the manufacturing of thick bearing component sections. The refined grains will lead to better toughness as well as higher strength and hardness of the final bearing steel product.

Immediately after austenitisation, the bearing components are quenched using a suitable medium, such that all the reconstructive transformation products are avoided during cooling and martensite, bainite (bainitic-ferrite), or both structures, are obtained in the steel microstructure with only small amount of retained austenite left after tempering of the martensite-containing components, or after the bainite transformation has ceased. Afterwards, the bearing components are typically cooled to room temperature.

Subsequent deep-freezing and/or tempering may be employed to further reduce the retained austenite content which ensures higher hardness and strength, with their positive effect on resistance to rolling contact fatigue. Additionally, lower retained austenite content is found to improve the dimensional stability of the bearing components allowing them to be used in demanding bearing applications where the application temperature is higher than usual.

Given its lower carbon content, the steel was found to be particularly suitable for surface induction hardening and tempering. In this case, the microstructure will typically comprise tempered martensite. Optional carbides/nitrides/carbonitrides may also be present.

The lower carbon content in the steel according to the present invention also means that it is easier to butt-weld the steel compared to conventional bearing steels with higher carbon contents.

### EXAMPLES

The invention will now be described further with reference to the following non-limiting examples.

Steel 1, comprising in wt. %

C: 0.75

Si: 0.1

Mn: 0.8

Mo: 0.7

Cr: 1.6

Ni: 0.1

Cu: 0.2

V: 0.1

P: max 0.01

S: max 0.015

As+Sn+Sb: max 0.075

Pb: max 0.002

Al: max 0.050

Fe: Balance

Oxygen level should be less than 10 ppm, Ti level less than 30 ppm and Ca level less than 10 ppm. Nitrogen is present as a trace element (at least 50 ppm). The maximum limit for As is 0.04 wt. %.

Steel 2, comprising in wt. %

C: 0.75

Si: 0.05

Mn: 0.8

Mo: 0.7

Cr: 1.6

Ni: 0.1

Cu: 0.2

V: 0.1

P: max 0.01

S: max 0.015

As+Sn+Sb: max 0.075

Pb: max 0.002

Al: max 0.050

Fe: Balance

Oxygen level should be less than 10 ppm, Ti level less than 30 ppm and Ca level less than 10 ppm. Nitrogen is present as a trace element (at least 50 ppm). The maximum limit for As is 0.04 wt. %.

Fully bainitic hardened components manufactured from the reference Steel compositions 1 and 2 above exhibited a hardness of about 60 HRC or higher.

Comparative Steel 1, comprising in wt. %

C: 0.75

Si: 0.2

Mn: 0.8

Mo: 0.36

Cr: 1.6

Ni: 0.1

Cu: 0.2

V: 0.1

P: max 0.01

S: max 0.015

As+Sn+Sb: max 0.075

Pb: max 0.002

Al: max 0.050

Fe: Balance

Oxygen level should be less than 10 ppm, Ti level less than 30 ppm and Ca level less than 10 ppm. Nitrogen is present as a trace element (at least 50 ppm). The maximum limit for As is 0.04 wt. %.

Comparative Steel 2, comprising in wt. %

C: 0.75

Si: 0.35

Mn: 0.8

Mo: 0.36

Cr: 1.6

Ni: 0.1

Cu: 0.2

V: 0.1

P: max 0.01

S: max 0.015

As+Sn+Sb: max 0.075

Pb: max 0.002

Al: max 0.050

Fe: Balance

Oxygen level should be less than 10 ppm, Ti level less than 30 ppm and Ca level less than 10 ppm. Nitrogen is present as a trace element (at least 50 ppm). The maximum limit for As is 0.04 wt. %.

Comparative Steel 3, comprising in wt. %

C: 0.75

Si: 0.05

Mn: 0.8

Mo: 0.5

Cr: 1.6

Ni: 0.1

Cu: 0.2

V: 0.1

P: max 0.01

S: max 0.015

As+Sn+Sb: max 0.075

Pb: max 0.002

Al: max 0.050

Fe: Balance

Oxygen level should be less than 10 ppm, Ti level less than 30 ppm and Ca level less than 10 ppm. Nitrogen is present as a trace element (at least 50 ppm). The maximum limit for As is 0.04 wt. %.

The effect on hardness retention upon tempering at 260° C. for 1 hour was investigated. For the reference steel compositions according to the above examples, the change in hardness (Vickers hardness, ΔHv) was approximately +7.5 (Steel 1), +4.5 (Steel 2), 0 (Comparative Steel 1), +7 (Comparative Steel 2), and −3 (Comparative Steel 3). Thus, the best results were obtained for Steels 1 and 2. Steels 1 and 2 also lend themselves to continuous casting because they exhibit reduced macro-segregation effects. While Comparative Steel 2 also exhibited a good result in terms of hardness, the high silicon content in this example (which is expected to improve tempering resistance) does not lend itself to continuous casting in view of relatively significant macro-segregation effects. The same is true of Comparative Steel 1, although to a lesser degree.

The following two further examples (V91 and V92) were also compared in terms of macrosegregation.

Comparative Steel V91, comprising in wt. %

C: 0.953

Si: 0.308

Mn: 0.671

Mo: 0.245

Cr: 1.721

Ni: 0.175

Cu: 0.155

V: 0.01

N: 0.0093

Al: 0.007

Nb: 0.002

Sn: 0.012

P: 0.017

S: 0.009

B: 0.0002

As+Sn+Sb: max 0.075

Fe: Balance

Oxygen level should be less than 10 ppm, Ti level less than 30 ppm and Ca level less than 10 ppm. The maximum limit for As is 0.04 wt. %.

Steel V92, comprising in wt. %

C: 0.749

Si: 0.134

Mn: 0.808

Mo: 0.705

Cr: 1.593

Ni: 0.114

Cu: 0.202

V: 0.112

N: 0.0049

Al: 0.007

Nb: 0.002

Sn: 0.002

P: 0.006

S: 0.005

B: 0.0003

As+Sn+Sb: max 0.075

Fe: Balance

Oxygen level should be less than 10 ppm, Ti level less than 30 ppm and Ca level less than 10 ppm. The maximum limit for As is 0.04 wt. %.

The two steel alloys V91 and V92 were melted in vacuum (Vacuum Induction Melted) and then cast in sand moulds. Their chemical compositions are recited above.

After casting, the head and the bottom of each steel ingot were sectioned and discarded.

Afterwards, the ingots were homogenised for a minimum of 6 hours at 1200° C., and then furnace cooled.

The ingots were cold-charged and heated to the said temperature at a rate of 100° C./hour. Once the desired temperature was reached, the total holding time was 8 hours to ensure that the central regions in each ingot are soaked for at least 6 hours, at temperature.

The furnace atmosphere was controlled by using a continuous nitrogen gas flow, initially with the rate 28 litre/min. During the cooling to room temperature, the nitrogen gas flow rate was increased to 100 litre/min. Nevertheless, the cooling rate of the ingots was sufficiently low.

Two slices were sectioned from each ingot and were then ground and finish-polished prior to macroetching in accordance with the ASTM E 381 standard to reveal the as-solidified structure of each alloy.

The macroetched sections for both alloys were then compared. The steel alloy V92 showed a structure that was finer than that of the comparative, reference steel alloy V91.

The bearing component according to the present invention is formed from a steel alloy having high hardness, relative weldability, hardenability and toughness, and resistance to rolling contact fatigue, wear and creep, as well as micro-defect tolerance. Moreover, it also exhibits reduced segregation during continuous casting.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A bearing component formed from a steel alloy comprising:
from 0.7 to 0.9 wt. % carbon,
from 0.05 to 0.16 wt. % silicon,
from 0.7 to 0.9 wt. % manganese,
from 1.4 to 2.0 wt. % chromium,
from 0.7 to 1.0 wt. % molybdenum,
from 0.03 to 0.15 wt. % vanadium,
from 0 to 0.25 wt. % nickel,
from 0 to 0.3 wt. % copper,
from 0 to 0.2 wt. % cobalt,
from 0 to 0.1 wt. % aluminium,
from 0 to 0.1 wt. % niobium,
from 0 to 0.2 wt. % tantalum,
from 0 to 0.025 wt. % phosphorous,
from 0 to 0.015 wt. % sulphur,
from 0 to 0.075 wt. % tin,
from 0 to 0.075 wt. % antimony,
from 0 to 0.04 wt. % arsenic,
from 0 to 0.002 wt. % lead,
up to 350 ppm nitrogen,
up to 20 ppm oxygen,
up to 50 ppm calcium,
up to 30 ppm boron,
up to 50 ppm titanium,
the balance iron, together with any unavoidable impurities.

2. The bearing component of claim 1, wherein the steel alloy comprises from 0.7 to 0.8 wt. % carbon.

3. The bearing component of claim 1, wherein the steel alloy comprises from 0.06 to 0.16 wt. % silicon.

4. The bearing component of claim 1, wherein the steel alloy comprises from 0.7 to 0.9 wt. % molybdenum.

5. The bearing component of claim 1, wherein the steel alloy comprises molybdenum and silicon in a weight ratio of 3.5≦Mo/Si≦33.3.

6. The bearing component of claim 1, wherein the steel alloy comprises molybdenum and chromium in a weight ratio of 0.35≦Mo/Cr≦0.71.

7. The bearing component of claim 1, wherein the steel alloy comprises chromium and carbon in a weight ratio of Cr/C ratio≦2.

8. The bearing component of claim 1, wherein the steel alloy comprises from 0.03 to 0.12 wt. % vanadium.

9. The bearing component of claim 1, wherein the steel alloy comprises from 50 to 350 ppm nitrogen.

10. The bearing component of claim 1, wherein the steel alloy comprises at least 100 ppm nitrogen.

11. The bearing component of claim 1, wherein the steel alloy has a bainitic and/or martensitic microstructure, optionally including carbides, nitrides and/or carbonitrides.

12. The bearing component of claim 1, wherein the bearing component is a rolling element or an inner ring or an outer ring for a bearing.

13. (canceled)

14. A process for the manufacture of a bearing component, comprising:
(i) continuously casting a steel alloy composition comprising:
from 0.7 to 0.9 wt. % carbon,
from 0.05 to 0.16 wt. % silicon,
from 0.7 to 0.9 wt. % manganese,
from 1.4 to 2.0 wt. % chromium,
from 0.7 to 1.0 wt. % molybdenum,
from 0.03 to 0.15 wt. % vanadium,
from 0 to 0.25 wt. % nickel,
from 0 to 0.3 wt. % copper,
from 0 to 0.2 wt. % cobalt,
from 0 to 0.1 wt. % aluminium,
from 0 to 0.1 wt. % niobium,
from 0 to 0.2 wt. % tantalum,
from 0 to 0.025 wt. % phosphorous,
from 0 to 0.015 wt. % sulphur,
from 0 to 0.075 wt. % tin,
from 0 to 0.075 wt. % antimony,
from 0 to 0.04 wt. % arsenic,
from 0 to 0.002 wt. % lead,
up to 350 ppm nitrogen,
up to 20 ppm oxygen,
up to 50 ppm calcium,
up to 30 ppm boron,
up to 50 ppm titanium,
the balance iron, together with any unavoidable impurities; and
(ii) forming a bearing component from the continuously cast steel alloy.
